(19) United States
(12) Patent Application Publication
(10) Pub. No.: US 2025/0054994 A1
(43) Pub. Date: Feb. 13, 2025

(54) NEGATIVE-ELECTRODE-FREE ALL-SOLID-STATE BATTERY AND METHOD FOR MANUFACTURING THE SAME

(71) Applicant: KOREA ELECTRONICS TECHNOLOGY INSTITUTE, Seongnam-si (KR)

(72) Inventors: Seung Ho CHOI, Seongnam-si (KR); Ji Sang YU, Seongnam-si (KR); Woo Suk CHO, Seongnam-si (KR); Kyung Su KIM, Seongnam-si (KR)

(21) Appl. No.: 18/797,448

(22) Filed: Aug. 7, 2024

(30) Foreign Application Priority Data
Aug. 7, 2023 (KR) 10-2023-0102623

(51) Int. Cl. H01M 4/66; H01M 4/02; H01M 10/052; H01M 10/0585; H01M 10/42; H01M 10/44

(52) U.S. Cl. CPC H01M 4/667; H01M 4/662; H01M 10/052; H01M 10/0585; H01M 10/4235; H01M 10/44; H01M 2004/027

(57) ABSTRACT

Disclosed are a negative-electrode-free all-solid-state battery and a method for manufacturing the same, in which the negative-electrode-free all-solid-state battery has a coating layer including a lithium alloy derived from a sulfide-based inorganic compound in which a lithium site is doped with a doping element, and thus has excellent electrochemical characteristics and life characteristics.

### CROSS-REFERENCE TO RELATED APPLICATION

This application claims priority from Korean Patent Application No. 10-2023-0102623 filed on Aug. 7, 2023 in the Korean Intellectual Property Office, and all the benefits accruing therefrom under 35 U.S.C. 119, the contents of which in its entirety are herein incorporated by reference.

The research project information of the present invention is as follows.
Project unique number: 20007045
Ministry name: Ministry of Trade, Industry and Energy
Research management specialized organization: Korea Institute of Industrial Technology Planning and Evaluation
Research project name: Industrial core technology development project
Research project name: (R) Development of a high-voltage battery system for electric vehicles with an ultra-fast charging function of about 1 minute
Main organization: Korea Electronics Technology Institute
Research period: 2019.09.01-2026.05.31

### BACKGROUND

### Field

The present disclosure relates to a negative-electrode-free all-solid-state battery and a method for manufacturing the same, in which the negative-electrode-free all-solid-state battery has a coating layer including a lithium alloy derived from a sulfide-based inorganic compound disposed on a negative-electrode current collector and thus has excellent electrochemical characteristics and life characteristics.

### Description of Related Art

Lithium ion batteries are widely used in various devices requiring energy storage. Depending on the application field thereof, various battery characteristics such as high energy density, long cycle life, fast charge/discharge, and high/low temperature battery operation performance are required.

Recently, the automobile industry, which is a means of transportation, is interested in electric vehicles using secondary batteries as fossil fuels are being avoided to solve environmental problems caused by carbon dioxide (CO₂). The vehicle using a currently developed lithium-ion battery may travel about 400 km per a single charge. However, problems such as instability and fire at high temperatures still exist. To solve these problems, many companies are competitively developing next-generation secondary batteries.

The all-solid-state battery, which is attracting attention as a next-generation secondary battery, has the advantage of having less risk of fire and explosion and higher mechanical strength, compared to the lithium-ion battery that uses flammable organic solvents as electrolytes because all of components thereof are solid. However, a negative-electrode active material layer of the all-solid-state battery is generally made of a mixture of the negative-electrode active material with a solid electrolyte to secure ion conductivity. However, since the solid electrolyte has a larger specific gravity than that of the liquid electrolyte, the conventional all-solid-state battery has a disadvantage of lower energy density than that of the lithium-ion battery.

To solve this problem, research is being conducted on a negative-electrode-free all-solid-state battery which is free of the negative electrode from the solid-state battery or in which only a small amount of the negative-electrode active material is used, and lithium precipitates in the form of metal on the negative-electrode current collector. However, when lithium ions are not stored in graphite but precipitate on the negative-electrode current collector in the form of lithium metal as described above, there is a problem that irreversible reactions gradually increase due to uneven precipitation of lithium or dendrite formation, and thus, the lifespan and durability of the battery are greatly reduced.

### SUMMARY

A purpose of the present disclosure is to provide a negative-electrode-free all-solid-state battery and a method for manufacturing the same, in which lithium is uniformly formed and removed and dendrites are not formed even when charge and discharge of the battery are repeated, thereby providing excellent lifespan and durability of the battery.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

According to one aspect of the present disclosure for achieving the above-described technical purpose, there is provided a negative-electrode-free all-solid-state battery comprising: a negative-electrode current collector; a coating layer disposed on the negative-electrode current collector; a solid electrolyte layer disposed on the coating layer; a positive-electrode active material layer disposed on the solid electrolyte layer and including a positive-electrode active material; and a positive-electrode current collector disposed on the positive-electrode active material layer, wherein the coating layer comprises a lithium alloy represented by Li-M, wherein M includes at least one selected from the group consisting of Ag, Na, K, Rb, Cs, Fr, and combinations thereof.

In accordance with some embodiments of the negative-electrode-free all-solid-state battery, the negative-electrode-free all-solid-state battery further comprises a lithium metal layer disposed between the coating layer and the negative-electrode current collector in a charged state of the battery.

In accordance with some embodiments of the negative-electrode-free all-solid-state battery, the coating layer comprises an alloy of lithium (Li) and silver (Ag).

In accordance with some embodiments of the negative-electrode-free all-solid-state battery, the coating layer further comprises LiₐP_{c}S_{d}Xₑ, wherein X includes at least one selected from the group consisting of F, Cl, Br, I, and combinations thereof, wherein 0<a≤15, 0≤c≤3, 0<d≤12, and 0≤e≤3.

In accordance with some embodiments of the negative-electrode-free all-solid-state battery, a thickness of the coating layer is in a range of 10 nm to 100 μm.

In accordance with some embodiments of the negative-electrode-free all-solid-state battery, when the negative-electrode-free all-solid-state battery is initially charged under application of a voltage of 1.8 V to 0 V thereto, the battery exhibits a flat level characteristic at 0.2 V to 0.0.5 V in a graph in which an X-axis represents a battery capacity (mAh/cm²) and a Y-axis represents the voltage (V).

In accordance with some embodiments of the negative-electrode-free all-solid-state battery, M in the lithium alloy represented by Li-M is derived from a sulfide-based inorganic compound represented by a following Chemical formula 1:

[Chemical Formula 1]

Li_{a-b}M_{b}P_{c}S_{d}Xₑ

wherein M includes at least one selected from the group consisting of Ag, Na, K, Rb, Cs, Fr, and a combination thereof,

wherein X includes at least one selected from the group consisting of F, Cl, Br, I, and combinations thereof,

wherein 0<a≤15, 0.02≤b≤0.9, 0≤c≤3, 0<d≤12, and 0≤e≤3.

In accordance with some embodiments of the negative-electrode-free all-solid-state battery, the sulfide-based inorganic compound has an argyrodite type crystal structure.

In accordance with some embodiments of the negative-electrode-free all-solid-state battery, a peak appearing at 2θ=29.8°±1.0° of an XRD result of the sulfide-based inorganic compound shifts to a smaller angle as b increases.

According to another aspect of the present disclosure for achieving the above-described technical purpose, there is provided a method for manufacturing a negative-electrode-free all-solid-state battery, the method comprising: coating a sulfide-based inorganic compound represented by a following Chemical Formula 1 on a negative-electrode current collector to form an interfacial layer on the negative-electrode current collector; stacking a solid electrolyte layer, a positive-electrode active material layer, and a positive-electrode current collector on the interfacial layer to obtain an intermediate stack; and charging and discharging the intermediate stack to convert the interfacial layer into a coating layer including a lithium alloy represented by Li-M,

[Chemical formula 1]

Li_{a-b}M_{b}P_{c}S_{d}Xₑ

wherein M includes at least one selected from the group consisting of Ag, Na, K, Rb, Cs, Fr, and a combination thereof,

wherein X includes at least one selected from the group consisting of F, Cl, Br, I, and combinations thereof,

wherein 0<a≤15, 0.02≤b≤0.9, 0≤c≤3, 0<d≤12, and 0≤e≤3.

In accordance with some embodiments of the method for manufacturing the negative-electrode-free all-solid-state battery, the sulfide-based inorganic compound has an argyrodite-type crystal structure.

In accordance with some embodiments of the method for manufacturing the negative-electrode-free all-solid-state battery, a peak appearing at 2θ=29.8°±1.0° of an XRD result of the sulfide-based inorganic compound shifts to a smaller angle as b increases.

In accordance with some embodiments of the method for manufacturing the negative-electrode-free all-solid-state battery, the converting of the interfacial layer into the coating layer including the lithium alloy represented by Li-M is irreversible.

In accordance with some embodiments of the method for manufacturing the negative-electrode-free all-solid-state battery, the interfacial layer is converted into the coating layer including the lithium alloy represented by Li-M under application of charging/discharging voltage of 0.7 V to 0.9 V to the intermediate stack.

In accordance with some embodiments of the method for manufacturing the negative-electrode-free all-solid-state battery, in charging and discharging the intermediate stack to convert the interfacial layer into the coating layer, the interfacial layer of a white color is converted into the coating layer of the black color, wherein a whiteness index of the white interfacial layer is 70 or higher, wherein a whiteness index of the black coating layer is 30 or lower.

In accordance with some embodiments of the method for manufacturing the negative-electrode-free all-solid-state battery, the negative-electrode-free all-solid-state battery further includes a lithium metal layer located between the coating layer and the negative-electrode current collector in a charged state of the battery.

In accordance with some embodiments of the method for manufacturing the negative-electrode-free all-solid-state battery, the coating layer comprises an alloy of lithium (Li) and silver (Ag).

In accordance with some embodiments of the method for manufacturing the negative-electrode-free all-solid-state battery, the coating layer further comprises LiₐP_{c}S_{d}Xₑ, wherein X includes at least one selected from the group consisting of F, CI, Br, I, and combinations thereof, wherein 0<a≤15, 0≤c≤3, 0<d≤12, and 0≤e≤3.

In accordance with some embodiments of the method for manufacturing the negative-electrode-free all-solid-state battery, the coating layer has a thickness in a range of 10 nm to 100 μm.

In accordance with some embodiments of the method for manufacturing the negative-electrode-free all-solid-state battery, when the negative-electrode-free all-solid-state battery is initially charged under application of a voltage of 1.8 V to 0 V thereto, the battery exhibits a flat level characteristic at 0.2 V to 0.05 V in a graph in which an X-axis represents a battery capacity (mAh/cm²) and a Y-axis represents the voltage (V).

According to the present disclosure, the coating layer is positioned between the negative-electrode current collector and the solid electrolyte layer, and the coating layer includes the lithium alloy represented by Li-M. Thus, the coating layer may play the role of a lithium ion induction layer when charging the negative-electrode-free all-solid-state battery.

In the negative-electrode-free all-solid-state battery, the lithium ions may be uniformly precipitated in the form of a lithium metal layer in an area between the coating layer and the negative-electrode current collector, and the formation of dendrites may be suppressed. Accordingly, the life characteristics and durability of the negative-electrode-free all-solid-state battery may be improved.

Effects of the present disclosure are not limited to the effects mentioned above, and other effects not mentioned will be clearly understood by those skilled in the art from the description below.

In addition to the above effects, specific effects of the present disclosure are described together while describing specific details for carrying out the present disclosure.

### BRIEF DESCRIPTION OF DRAWINGS

FIG. 1A schematically illustrates a discharged state of a negative-electrode-free all-solid-state battery according to the present disclosure.

FIG. 1B is a schematic diagram of a charged state of the negative-electrode-free all-solid-state battery according to the present disclosure.

FIG. 2 is a reference diagram for illustrating an initial charge-discharge process of the negative-electrode-free all-solid-state battery according to the present disclosure.

FIG. 3A is a scanning electron microscope (SEM) image of powders of a sulfide-based inorganic compound according to Present Example 1.

FIGS. 3B to 3E are images of the powders of the sulfide-based inorganic compound as illustrated in FIG. 3A as taken using an energy dispersive spectrometer (EDS).

FIG. 4A is a scanning electron microscope (SEM) image of powders of a sulfide-based inorganic compound according to Present Example 2.

FIGS. 4B to 4E are images of the powders of the sulfide-based inorganic compound shown in FIG. 4A as taken using energy dispersive X-ray spectroscopy (EDS).

FIG. 5A shows a result of XRD (X-ray diffraction) analysis of the powders of the sulfide-based inorganic compound according to each of Present Examples 1 to 7 and Comparative Example 1.

FIG. 5B is an enlarged image of a region around 2θ=30° of FIG. 5A.

FIG. 6A show a result of an XRD (X-ray diffraction) analysis of the powders of the sulfide-based inorganic compound according to each of Present Example 8 and Comparative Example 2.

FIG. 6B is an enlarged image of a region around 2θ=29° of FIG. 6A.

FIG. 7 is a voltage-capacity graph at initial charge-discharge of a half-cell according to a manufacturing example.

FIG. 8 shows a result of measuring a capacity while increasing charge/discharge cycles of a half-cell according to a manufacturing example.

FIG. 9 shows a voltage-capacity graph when a half-cell according to a manufacturing example operates at 2 to 20 cycles.

FIG. 10 shows a result of XRD analysis of a coating layer of a half-cell according to a manufacturing example.

FIG. 11 shows images of states of a half-cell according to a manufacturing example before and after the initial charge thereof.

FIG. 12 shows an observation result of a disassembled state of a full cell including a coating layer according to the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and embodiments of the present disclosure are not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “connected to” another clement or layer, it may be directly on, connected to, or connected to the other clement or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

The features of the various embodiments of the present disclosure may be partially or entirely combined with each other, and may be technically associated with each other or operate with each other. The embodiments may be implemented independently of each other and may be implemented together in an association relationship.

It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations.

The terms used in the description below have been selected as being general and universal in the related technical field. However, there may be other terms than the terms depending on the development and/or change of technology, convention, preference of technicians, etc. Therefore, the terms used in the description below should not be understood as limiting technical ideas, but should be understood as examples of the terms for illustrating embodiments.

Unless otherwise specified, all numbers, values, and/or expressions expressing quantities of components, reaction conditions, quantities of polymer compositions, and blends used herein are approximations that reflect, among other things, the various uncertainties of measurement that arise in obtaining such values and the numbers, and therefore should be understood to be modified in all instances by the term “about.” Furthermore, where a numerical range is disclosed herein, the numerical range is continuous and includes all values in a range from the minimum value to the maximum value, including the minimum value and the maximum value, unless otherwise indicated. Furthermore, where the numerical range refers to an integer, all integers in a range from the minimum value to the maximum value, including the minimum value and the maximum value are included in the numerical range, unless otherwise specified.

Negative-electrode-free all-solid-state battery

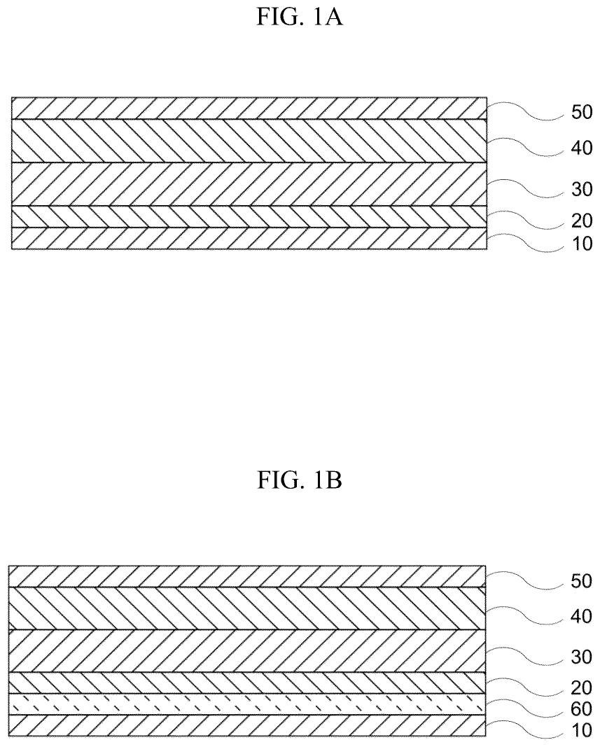

FIG. 1A illustrates a negative-electrode-free all-solid-state battery according to the present disclosure. The negative-electrode-free all-solid-state battery according to the present disclosure may include a negative-electrode current collector 10, a coating layer 20 disposed on the negative-electrode current collector 10, a solid electrolyte layer 30 disposed on the coating layer 20, a positive-electrode active material layer 40 disposed on the solid electrolyte layer 30, and a positive-electrode current collector 50 disposed on the positive-electrode active material layer 40.

FIG. 1B illustrates a charged state of the negative-electrode-free all-solid-state battery according to the present disclosure. Referring to FIG. 1B, when the negative-electrode-free all-solid-state battery is charged, lithium ions migrated from the positive-electrode active material layer 40 may be precipitated in the form of lithium metal and/or lithium alloy in an area between the coating layer 20 and the negative-electrode current collector 10. That is, the negative-electrode-free all-solid-state battery in a charged state may include a lithium metal layer 60 including the lithium metal and/or lithium alloy disposed between the coating layer 20 and the negative-electrode current collector 10.

The negative-electrode current collector 10 may be a plate-shaped substrate having electrical conductivity. Specifically, the negative-electrode current collector 10 may have a form of a sheet, a thin film, or a foil. The negative-electrode current collector 10 may be embodied as a high-density metal thin film having a porosity lower than about 1%. Furthermore, the negative-electrode current collector 10 may have a thickness of 1 μm to 20 μm, or 5 μm to 15 μm.

The negative-electrode current collector 10 may include a material that does not react with lithium. Specifically, the negative-electrode current collector 10 may include at least one selected from the group consisting of Ni, Cu, SUS (Stainless steel), and combinations thereof.

On the negative-electrode current collector 10, the coating layer 20 including a lithium alloy represented by Li-M (M includes at least one selected from the group consisting of Ag, Na, K, Rb, Cs, Fr, and combinations thereof) may be positioned. A doping element M may include all elements that may exist as a monovalent cation having an ionic radius larger than that of a lithium cation (Li⁺) when being in an ionic state, and specifically, may include silver (Ag), sodium (Na), potassium (K), rubidium (Rb), cesium (Cs), francium (Fr), etc.

For example, the coating layer 20 may include an alloy of lithium (Li) and silver (Ag).

In the lithium alloy represented by Li-M as set forth above, “-” may mean that the lithium element and the doping element M form an alloy with each other. In this regard, the alloy is generally classified into a solid solution and an intermetallic compound, and the lithium alloy represented by Li-M may be a solid solution.

The solid solution means that another type of solid is dissolved in one type of solid to form a monolithic solid, and atoms of different types of solids may be mixed with each other to form a single crystal structure. The solid solution may be classified into an interstitial solid solution in which atoms of another type of an element are inserted into gaps between atoms of one type of an element, and a substitutional solid solution in which at least one of atoms of one type of an element that are arranged regularly is pushed out by and replaced with an atom of another type of an element.

When atomic sizes of the lithium and the doping element M that form the alloy with each other are similar to each other, the lithium alloy may exist in the form of the substitutional solid solution. When a difference between the atomic sizes of the lithium and the doping element M is large, the lithium alloy may exist in the form of the interstitial solid solution. For example, when the coating layer 20 includes an alloy of lithium (Li) and silver (Ag), the alloy of Li—Ag may exist in the form of a substitutional solid solution.

The coating layer 20 may play a role in inducing lithium ions when the negative-electrode-free all-solid-state battery is charged. The lithium alloy represented by Li-M has high lithium ion conductivity, so that lithium ions may be uniformly precipitated in the form of a metal layer disposed between the coating layer 20 and the negative-electrode current collector 10 when charging an all-solid-state battery. That is, the coating layer 20 may suppress uneven precipitation of lithium and the formation of dendrites, and thus the life characteristics and durability of the negative-electrode-free all-solid-state battery may be improved.

In the lithium alloy represented by Li-M included in the coating layer 20, M may be derived from a sulfide-based inorganic compound represented by a following Chemical formula 1:

[Chemical formula 1]

Li_{a-b}M_{b}P_{c}S_{d}Xₑ

(The M includes at least one selected from the group consisting of Ag, Na, K, Rb, Cs, Fr, and combinations thereof, and the X includes at least one selected from the group consisting of F, Cl, Br, I, and combinations thereof, wherein 0<a≤15, 0.02≤b≤0.9, 0 ≤c≤3, 0<d≤12, 0≤e≤3.)

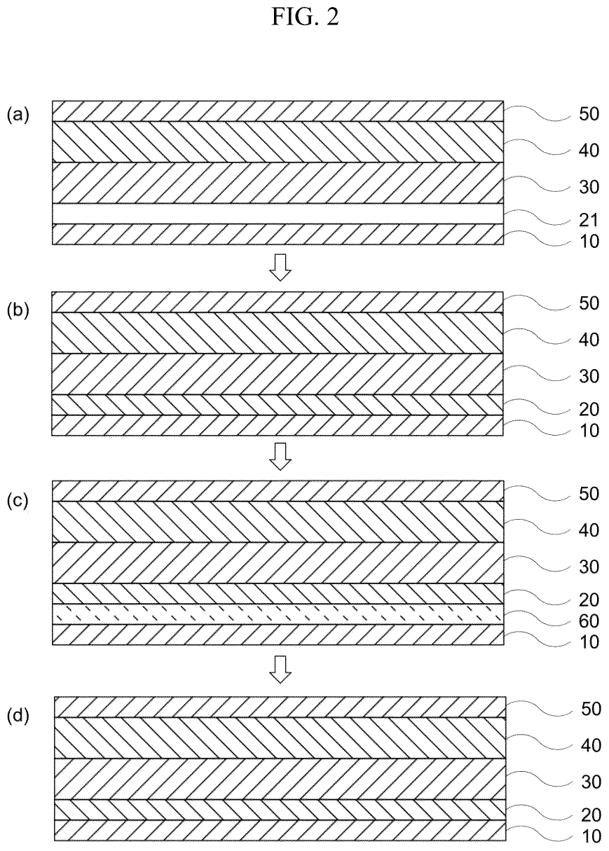

FIG. 2 is a reference diagram for illustrating a charge/discharge process of a negative-electrode-free all-solid-state battery according to the present disclosure. In FIG. 2, (a) shows a negative-electrode-free all-solid-state battery in its as-manufactured state without being subjected to charging. In FIG. 2, (b) shows an initial state thereof when being subjected to an initial charging. In FIG. 2, (c) shows a state thereof after the initial charging has been completed. In FIG. 2, (d) shows a state thereof after initial discharging has been completed.

As described below, before the initial charging, the negative-electrode-free all-solid-state battery may include an interfacial layer 21 including the sulfide-based inorganic compound represented by the Chemical Formula 1 and disposed on the negative-electrode current collector 10.

The interfacial layer 21 may be converted into the coating layer 20 including the lithium alloy represented by Li-M during the charging process.

When the negative-electrode-free all-solid-state battery according to (a) of FIG. 2 is charged, the doping element M of the sulfide-based inorganic compound migrates along a lithium ion migration path in the sulfide-based inorganic compound in a form of M⁺ and escapes to an outside from a particle interface of the sulfide-based inorganic compound. The M⁺ that has escaped to the outside is reduced to the metal M. Alternatively, when the sulfide-based inorganic compound is decomposed at a low voltage, the metal M may be produced as a decomposition product.

The metal M reacts with lithium ions (Li⁺) that have migrated from the positive-electrode active material layer 40 to the interfacial layer 21 through the solid electrolyte layer 30 to form a lithium alloy represented by Li-M. That is, as shown in (b) of FIG. 2, during the initial charging of the negative-electrode-free all-solid-state battery, the interfacial layer 21 is converted into the coating layer 20 including the lithium alloy and LiₐP_{c}S_{d}Xₑ (X, a, c, d, and e are the same as defined above in the Chemical Formula 1). The LiₐP_{c}S_{d}Xₑ may be a compound in which the doping element M has been removed from the sulfide-based inorganic compound represented by the Chemical Formula 1. When the charging process progresses further and a significant portion of the metal M constitutes the lithium alloy, the lithium ions are precipitated in the form of lithium metal in pores present in the coating layer 20. As a result, the coating layer 20 may include the lithium alloy represented by Li-M, LiₐP_{c}S_{d}Xₑ, and the lithium metal produced via the precipitation of lithium ions.

The number of the pores in the coating layer 20 is not great. Thus, when the charging is in progress, the lithium ions released from the positive-electrode active material layer 40 are stored in a form of the lithium metal layer 60 disposed between the coating layer 20 and the negative-electrode current collector 10, as shown in (c) of FIG. 2.

When the negative-electrode-free all-solid-state battery according to (c) of FIG. 2 is discharged, the lithium metal layer 60 is ionized and returns to the positive-electrode active material layer 40, as shown in (d) of FIG. 2. At this time, the coating layer 20 remains without returning to the interfacial layer 21 including the sulfide-based inorganic compound represented by the Chemical Formula 1. That is, the coating layer 20 of the negative-electrode-free all-solid-state battery according to the present disclosure may include the lithium alloy represented by Li-M and LiₐP_{c}S_{d}Xₑ in the discharged state of the battery.

As described above, the battery of the present disclosure is characterized in that the coating layer 20 including the lithium alloy using the sulfide-based inorganic compound doped with the element M capable of reacting with lithium to form the alloy. A series of layers disposed on the negative-electrode current collector and formed by physically mixing powders of the metal M and powders of LiₐP_{c}S_{d}Xₑ cannot form a lithium alloy represented by Li-M as the coating layer 20 according to the present disclosure does. Since the powders of LiₐP_{c}S_{d}Xₑ has very low electronic conductivity, the metal M surrounded with the powders of LiₐP_{c}S_{d}Xₑ cannot electrochemically react with lithium ions. Furthermore, it is not easy to uniformly mix the powders of the metal M and the powders of LiₐP_{c}S_{d}Xₑ with each other.

According to the present disclosure, the element M is added, on an atom basis, into a structure of the sulfide-based inorganic compound, so that the element M is discharged to the outside through a migration path of the lithium ions in the sulfide-based inorganic compound, thereby forming the metal M in an entire surface of the sulfide-based inorganic compound. Therefore, the metal M may react with lithium ions, and accordingly, the lithium alloy represented by Li-M may be formed. In one example, when the sulfide-based inorganic compound does not contain X, the coating layer 20 may not contain LiX in the charged state of the battery.

In one embodiment, a thickness of the coating layer 20 may be in a range of 10 nm to 100 μm, or 5 um to 30 μm.

When the thickness of the coating layer 20 is smaller than 10 nm, it is difficult to manufacture the coating layer 20, and the coating layer 20 may not properly induce lithium ions, so that the lithium metal may be unevenly precipitated.

When the thickness of the coating layer 20 exceeds 100 μm, the energy density of the negative-electrode-free all-solid-state battery may decrease.

The solid electrolyte layer 30 may be positioned between the coating layer 20 and the positive-electrode active material layer 40 and may transfer lithium ions between the two components. The solid electrolyte layer 30 may include a solid electrolyte having lithium ion conductivity.

The solid electrolyte may include at least one selected from the group consisting of oxide-based solid electrolytes, sulfide-based solid electrolytes, polymer electrolytes, and combinations thereof. In one example, the solid electrolyte may include the sulfide-based solid electrolyte having high lithium ion conductivity.

The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (where m and n are positive numbers, and Z is one of Ge, Zn, and Ga), Li₂S—GeS₂, Li₂S—SiS₂—Li₃PO₄, Li₂S—SiS₂—LiₓMO_{y} (where x and y are positive numbers, M is one of P, Si, Ge, B, Al, Ga, and In), and, Li₁₀GeP₂S₁₂.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), etc.

The polymer electrolyte may include gel polymer electrolyte, solid polymer electrolyte, etc.

The solid electrolyte layer 30 may further include a binder. The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), etc.

The positive-electrode active material layer 40 reversibly absorbs and releases lithium ions, and may include a positive-electrode active material, a conductive material, a binder, etc. Furthermore, the positive-electrode active material layer 40 may include a portion of the solid electrolyte.

The positive-electrode active material may be an oxide active material or a sulfide active material.

The oxide active material may be a rock salt layer-type active material such as LiCoO₂, LiMnO₂, LiNiO₂, LiVO₂, Li₁₊ₓNi_{1/3}Co_{1/3}Mn_{1/3}O₂, a spinel-type active material such as LiMn₂O₄, Li(Ni_{0.5}Mn_{1.5})O₄, a reverse spinel-type active material such as LiNiVO₄, LiCoVO₄, an olivine-type active material such as LiFePO₄, LiMnPO₄, LiCoPO₄, LiNiPO₄, etc., a silicon-containing active material such as Li₂FeSiO₄, Li₂MnSiO₄, etc., a rock salt layer-type active material in which a portion of the transition metal is replaced with a dissimilar metal such as LiNi_{0.8}Co_{(0.2-x)}AlₓO₂(0<x<0.2), a spinel-type active material in which a portion of the transition metal is replaced with a dissimilar metal such as Li₁₊ₓMn_{2-x-y}MyO₄ (M is at least one of Al, Mg, Co, Fe, Ni, and Zn, 0<x+y<2), or lithium titanate such as Li₄Ti₅O₁₂, etc.

The sulfide active material may be copper chevrel, iron sulfide, cobalt sulfide, nickel sulfide, etc.

The solid electrolyte added to the positive-electrode active material layer 40 may be substantially the same as or different from the solid electrolyte included in the solid electrolyte layer 30.

The solid electrolyte may include at least one selected from the group consisting of oxide-based solid electrolyte, sulfide-based solid electrolyte, polymer electrolyte, and combinations thereof. In one example, the solid electrolyte may include a sulfide-based solid electrolyte having high lithium ion conductivity. Specific examples of the oxide-based solid electrolyte, the sulfide-based solid electrolyte, the polymer electrolyte, etc. are the same as described above.

The above-mentioned conductive material may include carbon black, conductive graphite, ethylene black, carbon fiber, graphene, etc.

The above-mentioned binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), etc.

The above-mentioned positive-electrode current collector 50 may be an electrically conductive plate-shaped substrate. Specifically, the above-mentioned positive-electrode current collector 50 may have a sheet or thin film form. The positive-electrode current collector 50 may include at least one selected from the group consisting of indium (In), copper (Cu), magnesium (Mg), aluminum (Al), stainless steel, iron, and combinations thereof. Specifically, the positive-electrode current collector 50 may include an aluminum foil.

In one embodiment, the negative-electrode-free all-solid-state battery may further include the lithium metal layer 60 positioned between the coating layer 20 and the negative-electrode current collector 10 in a charged state of the battery.

Specifically, when a voltage is applied to the negative-electrode-free all-solid-state battery to charge the battery, lithium is released in a form of ions from the positive-electrode active material present in the positive-electrode active material layer 40 and migrates toward the negative-electrode. The lithium ions released from the positive-electrode active material migrate through the solid electrolyte layer 30 and reach the coating layer 20. The lithium ions may migrate through the coating layer 20 having high lithium ion conductivity and be precipitated in a form of lithium metal and/or lithium alloy in an area between the coating layer 20 and the negative-electrode current collector 10 to form the lithium metal layer 60.

In one embodiment, when the negative-electrode-free all-solid-state battery is initially charged at a voltage of 1.8 V to 0 V, the battery may exhibit a flat level characteristic at 0.2 V to 0.05 V in a graph in which an X-axis represents a battery capacity (mAh/cm²) and a Y-axis represents the voltage (V).

The flat level characteristic may be observed as, during the initial charging process of the negative-electrode-free all-solid-state battery, the sulfide-based inorganic compound as described below is decomposed such that the lithium alloy represented by Li-M is formed.

### Method for Manufacturing Negative-Electrode-Free All-Solid-State Battery

According to another aspect of the present disclosure, a method for manufacturing a negative-electrode-free all-solid-state battery is provided, the method including a step of coating a sulfide-based inorganic compound represented by the following Chemical Formula 1 on the negative-electrode current collector 10 to form an interfacial layer 21 thereon, a step of sequentially stacking the solid electrolyte layer 30, the positive-electrode active material layer 40, and the positive-electrode current collector 50 on the interfacial layer to obtain an intermediate stack, and a step of charging and discharging the intermediate stack to convert the interfacial layer into the coating layer 20 including the lithium alloy represented by Li-M (M includes at least one selected from the group consisting of Ag, Na, K, Rb, Cs, Fr, and combinations thereof).

[Chemical formula 1]

Li_{a-b}M_{b}P_{c}S_{d}Xₑ

(The M includes at least one selected from the group consisting of Ag, Na, K, Rb, Cs, Fr, and combinations thereof, and the X includes at least one selected from the group consisting of F, Cl, Br, I, and combinations thereof, wherein 0<a≤15, 0.02≤b≤0.9, 0≤c≤3, 0<d≤12, 0≤e≤3.)

The sulfide-based inorganic compound represented by the Chemical Formula 1 may be prepared by mixing an inorganic compound precursor and a doping precursor with each other and then performing a heat treatment of the mixture. The inorganic compound precursor may include a precursor compound generally used to prepare the sulfide-based solid electrolyte, and may include, for example, Li₂S, P₂S₅, LiX, simple substance lithium, simple substance sulfur, simple substance phosphorus, etc. In this regard, the “simple substance” may mean a simple substance that is composed of a single element and exhibits unique chemical properties.

The doping precursor may include a compound precursor including the element M to be substitutionally doped into the sulfide-based inorganic compound. For example, the doping precursor may include MX (wherein M includes at least one selected from the group consisting of Ag, Na, K, Rb, Cs, Fr, and combinations thereof, and X includes at least one selected from the group consisting of F, Cl, Br, I, and combinations thereof). The MX may include, for example, AgF, AgCl, AgBr, and AgI.

The sulfide-based inorganic compound may have an argyrodite type crystal structure. The argyrodite type crystal structure has the same structure as that of the ore Ag₈GeS₆ and exhibits high lithium ion conductivity, and may be represented by Li_{7-b}M_{b}PS₅X, Li_{5-b}M_{b}PS₄X₂, Li_{6-b}M_{b}PS₅X, Li₇₋₆M_{b}P₂S₈X, Li_{4-b}M_{b}PS₄X, etc. In the sulfide-based inorganic compound represented by the above Chemical Formula 1, a Li-site of the sulfide-based inorganic compound as the base may be substitutionally doped with the element M.

As a value of b increases in the above sulfide-based inorganic compound, the peak appearing at 2θ=29.8°±1.0° of the XRD result may shift to a smaller angle. In the XRD analysis of the above sulfide-based inorganic compound, the shift of the peak to the smaller angle means that the distance between lattice planes or the interplanar spacing (d) has increased, which may be due to the substitutional doping of the element M having a larger ionic radius than that of the lithium ion into the Li-site of the sulfide-based inorganic compound.

A coating scheme of coating the interfacial layer is not particularly limited, and may employ any scheme that is widely used in the technical field to which the present disclosure belongs.

When a voltage is applied to the intermediate stack which thus is charged, the sulfide-based inorganic compound may be decomposed at a predetermined voltage, such that the interfacial layer may be converted into the coating layer 20. During the decomposition process of the sulfide-based inorganic compound, the doping element M may form the alloy together with lithium to form the lithium alloy represented by Li-M. Furthermore, the remaining elements Li, S, P, or X included in the sulfide-based inorganic compound may form Li₂S, Li₃P, and LiX.

Accordingly, the coating layer 20 may include the lithium alloy represented by Li-M and may further include at least one of Li₂S, Li₃P, and LiX.

In one embodiment, the step of converting the interfacial layer into the coating layer 20 including the lithium alloy represented by Li-M may be irreversible. That is, at least a portion of the lithium alloy may not be converted back into the sulfide-based inorganic compound during the discharging process of the negative-electrode-free all-solid-state battery.

In one embodiment, the interfacial layer may be converted into the coating layer 20 including a lithium alloy represented by Li-M under application of a charge/discharge voltage of 0.7 V to 0.9 V.

Specifically, the interfacial layer may be converted into the coating layer 20 under the application of the charge/discharge voltage of 1.6 V.

In one embodiment, in the step of charging and discharging the intermediate stack to convert the interfacial layer into the coating layer 20, the white interfacial layer may be converted into the black coating layer 20.

Specifically, the interfacial layer includes the sulfide-based inorganic compound. Since the sulfide-based inorganic compound exhibits white color, the interfacial layer may be white. The coating layer 20 may include the metal M or the lithium alloy represented by Li-M, and may further include at least one of Li₂S, Li₃P, and LiX. In this regard, the Li-M exhibits the black color, and Li₂S, Li₃P, and LiX exhibit the white color. Thus, a content of the metal M or the lithium alloy represented by Li-M increases, a color of the coating layer 20 may change to black.

Accordingly, the intermediates stack including the interfacial layer is charged and discharged such that the stack is converted to the coating layer 20 and then, the color of the coating layer 20 is observed with the naked eye and the observed color is the black. This may mean that the coating layer 20 includes the lithium alloy represented by Li-M.

As used herein, a whiteness index of the white interfacial layer may be 70 or higher, and the whiteness index of the black coating layer 20 may be 30 or lower.

As used herein, the whiteness index refers to the international standard CIE whiteness index, and “CIE whiteness index” refers to the whiteness index as measured using the AATCC (American Association of Textile Chemists and Colorists) test method 110-1994 and calculated using the formula set forth in the test method based on the light source D65 and the observer angle of 1976 10°. The CIE whiteness index is represented by a numerical value from 0 to 100, and the higher the value, the greater the whiteness. However, the whiteness index of the light-emitting body may exceed 100.

The sulfide-based inorganic compound included in the interfacial layer is white. Thus, when the whiteness index of the interfacial layer is lower than 70, this may mean that impurities other than the sulfide-based inorganic compound are contained therein. The lithium alloy included in the coating layer 20 is black. Thus, when the whiteness index of the coating layer 20 exceeds 30, this may mean that the lithium alloy is not completely formed.

Since each of the components of the negative-electrode-free all-solid-state battery manufactured according to the manufacturing method of the negative-electrode-free all-solid-state battery is substantially the same as that of the negative-electrode-free all-solid-state battery as described above, a detailed description of the components may be redundant and thus may be omitted.

Hereinafter, the present disclosure will be described in detail with reference to following Present Examples and Comparative Examples. However, the technical idea of the present disclosure is not limited or restricted thereto.

### Present Example 1. Li₆PS₅Cl+Ag 0.1

Lithium sulfide (Li₂S) powders (purchased from Sigma Aldrich), phosphorus pentasulfide (P₂S₅) powders (purchased from Sigma Aldrich), lithium chloride (LiCl) powders, and silver chloride (AgCl) powders as precursors of the sulfide-based inorganic compound were weighed and prepared according to the composition of Li_{5.9}Ag_{0.1}PS₅Cl.

The prepared precursor powders were placed into a stirrer and mixed with each other at a speed of about 450 rpm for about 2 hours, and then the mixture was heat-treated at a temperature of about 550° C. in a vacuum atmosphere to obtain the sulfide-based inorganic compound.

### Present Example 2. Li₆PS₅Cl+Ag 0.3

A sulfide-based inorganic compound was obtained through the same process as in Present Example 1, except that the precursors of the sulfide-based inorganic compound were weighed and prepared according to the composition of Li_{5.7}Ag_{0.3}PS₅Cl.

### Present Example 3. Li₆PS₅Cl+Ag 0.4

A sulfide-based inorganic compound was obtained through the same process as in Present Example 1, except that the precursors of the sulfide-based inorganic compound were weighed and prepared according to the composition of Li_{5.6}Ag_{0.4}PS₅Cl.

### Present Example 4. Li₆PS₅Cl+Ag 0.5

A sulfide-based inorganic compound was obtained through the same process as in Present Example 1, except that the precursors of the sulfide-based inorganic compound were weighed and prepared according to the composition of Li_{5.5}Ag_{0.5}PS₅Cl.

### Present Example 5. Li₆PS₅Cl+Ag 0.6

A sulfide-based inorganic compound was obtained through the same process as in Present Example 1, except that the precursors of the sulfide-based inorganic compound were weighed and prepared according to the composition of Li_{5.4}Ag_{0.6}PS₅Cl.

### Present Example 6. Li₆PS₅Cl+Ag 0.02

A sulfide-based inorganic compound was obtained through the same process as in Present Example 1, except that the precursors of the sulfide-based inorganic compound were weighed and prepared according to the composition of Li_{5.98}Ag_{0.02}PS₅Cl.

### Present Example 7. Li₆PS₅Cl+Ag 0.06

A sulfide-based inorganic compound was obtained through the same process as in Present Example 1, except that the precursors of the sulfide-based inorganic compound were weighed and prepared according to the composition of Li_{5.94}Ag_{0.06}PS₅Cl.

### Present Example 8. Li₃PS₄+Ag 0.1

Lithium sulfide (Li₂S) powders (purchased from Sigma Aldrich), phosphorus pentasulfide (P₂S₅) powders (purchased from Sigma Aldrich), and silver sulfide (Ag₂S) powders as precursors of the sulfide-based inorganic compound were weighed and prepared according to the composition of Li_{2.9}Ag_{0.1}PS₄.

The prepared precursor powders were placed into a stirrer and mixed with each other at a speed of about 450 rpm for about 2 hours, and then the mixture was heat-treated at a temperature of about 200° C. in a vacuum atmosphere to obtain the sulfide-based inorganic compound.

### Comparative Example 1. Li₆PS₅Cl

A sulfide-based inorganic compound was obtained through the same process as in Present Example 1, except that the silver chloride (AgCl) powders were not added during the process of preparing the precursors. The composition of the inorganic compound according to Comparative Example 1 was identified as Li₆PS₅Cl.

### Comparative Example 2. Li₃PS₄

A sulfide-based inorganic compound was obtained through the same process as in Present Example 8, except that the silver sulfide (Ag₂S) powders were not added during the process of preparing the precursors. The composition of the inorganic compound according to Comparative Example 2 was identified as Li₃PS₄.

### Experimental Example 1

In order to visually identify the types of elements included in the inorganic compound synthesized according to Present Example 1, the sulfide-based inorganic compound according to Present Example 1 was photographed using a scanning electron microscope (SEM) and an energy dispersive spectrometer (EDS), and then the photographed images are depicted in FIGS. 2A to 2E, respectively.

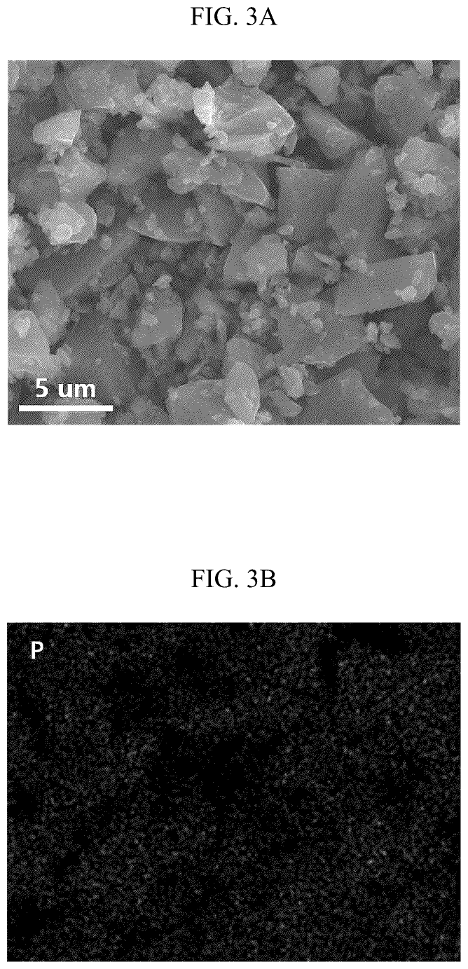

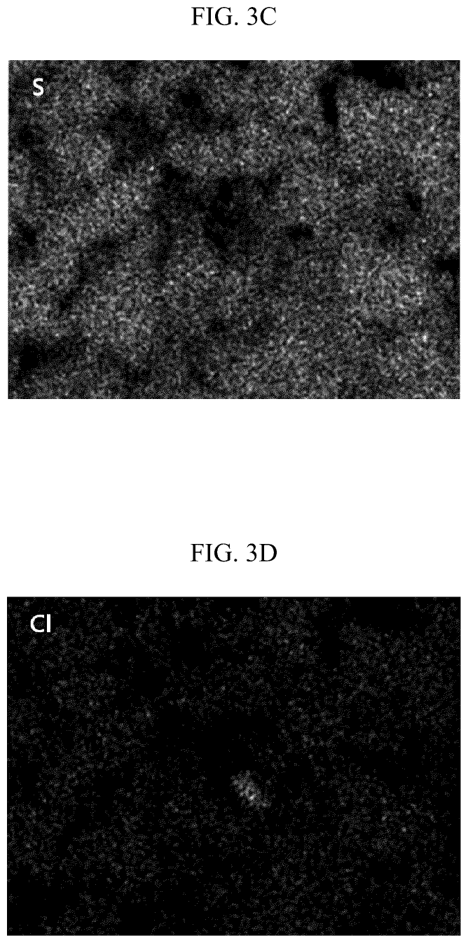

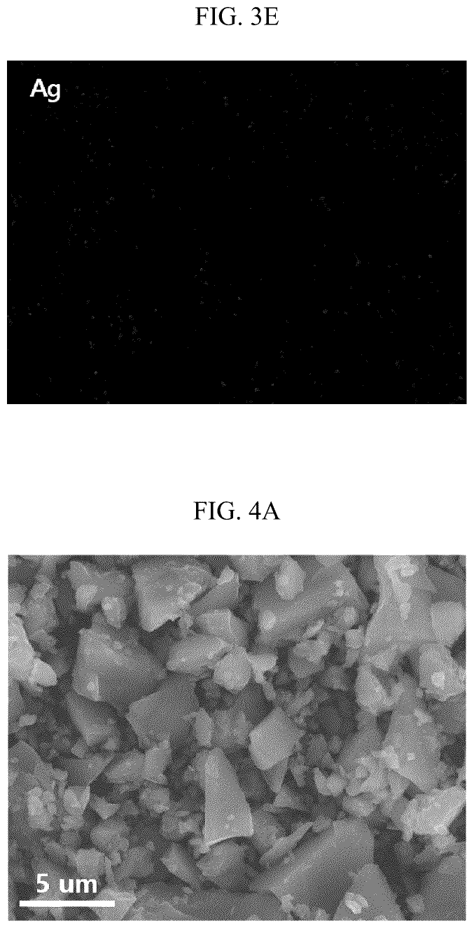

According to FIG. 3A, it may be identified that a powder-type sulfide-based inorganic compound was synthesized. Furthermore, with referring to FIGS. 3B to 3E, it may be identified that the doping element Ag is correctly doped into the inorganic compound based on the fact that the sulfide-based inorganic compound includes P, S, Cl, and Ag.

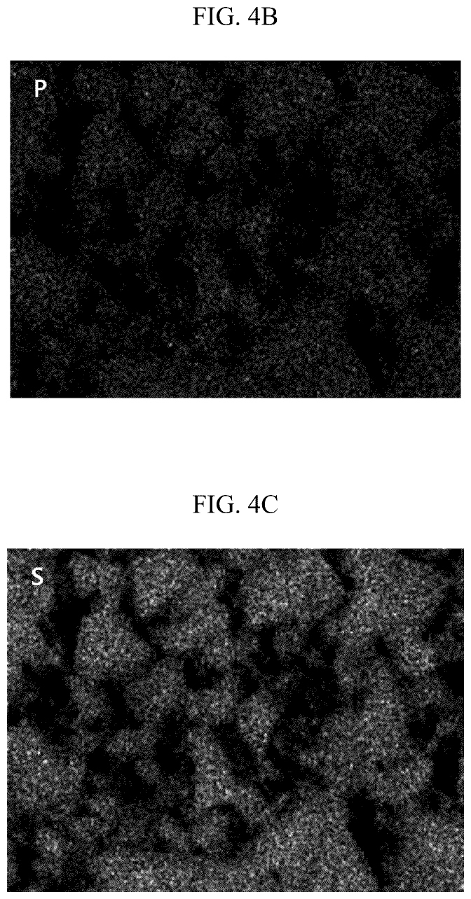

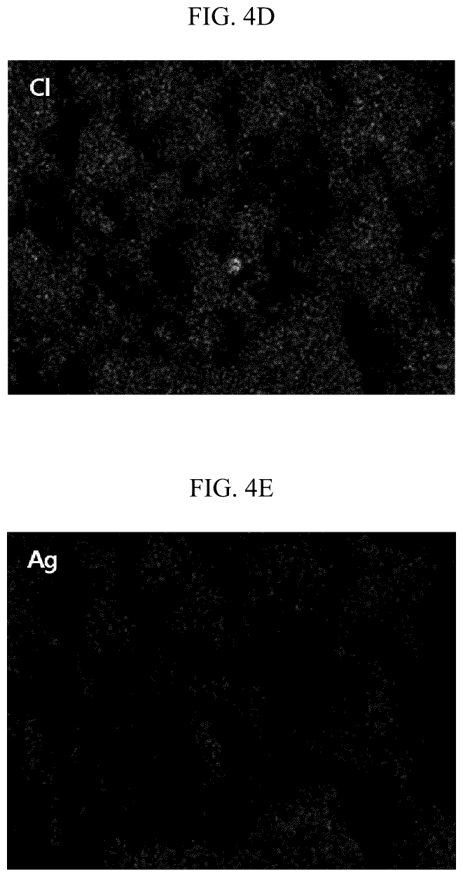

In order to visually identify the types of elements included in the inorganic compound synthesized according to Present Example 2, the sulfide-based inorganic compound according to Present Example 2 was photographed using a scanning electron microscope (SEM) and an energy dispersive spectrometer (EDS), and then the photographed images are shown in FIGS. 4A to 4E, respectively.

According to FIG. 4A, it may be identified that a powder-type sulfide-based inorganic compound was synthesized. Furthermore, with referring to FIGS. 4B to 4E, it may be identified that the sulfide-based inorganic compound is correctly doped with the doping element Ag based on the fact that P, S, Cl, and Ag are included in the sulfide-based inorganic compound.

### Experimental Example 2

In order to identify the composition of the sulfide-based inorganic compound synthesized according to each of Present Examples and Comparative Examples, XRD analysis was performed thereon. A reference peak was set to a peak of Si.

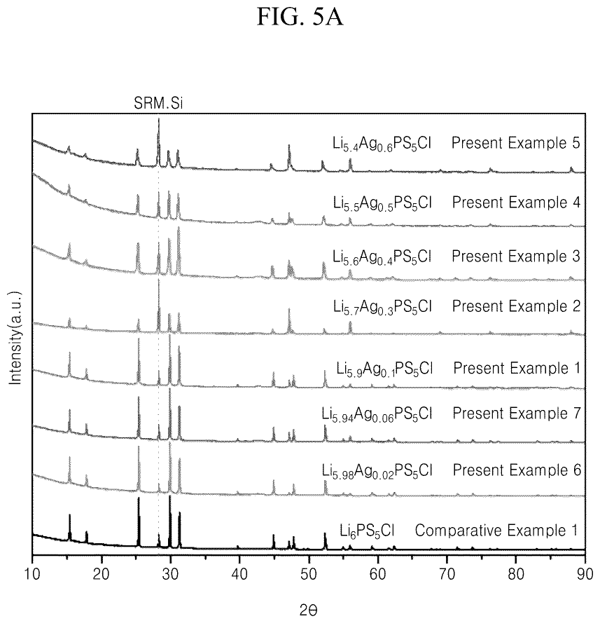

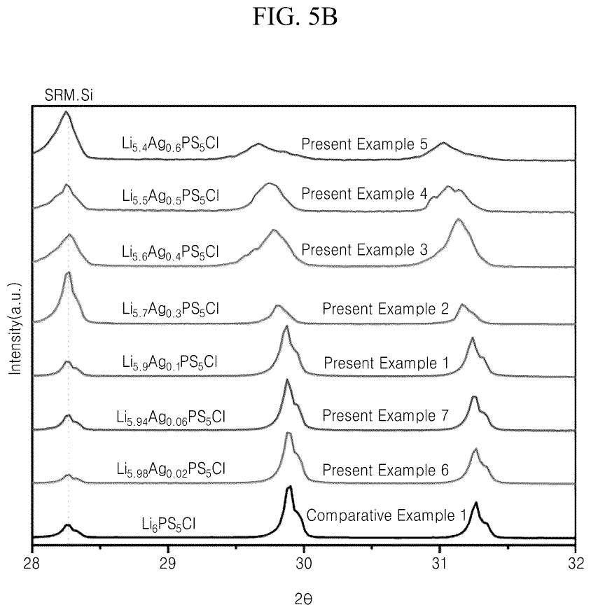

The results on Present Example 1 to Present Example 7 and Comparative Example 1 are shown in FIG. 5A. FIG. 5B is an enlarged image of a region around 2θ=30° of FIG. 5A.

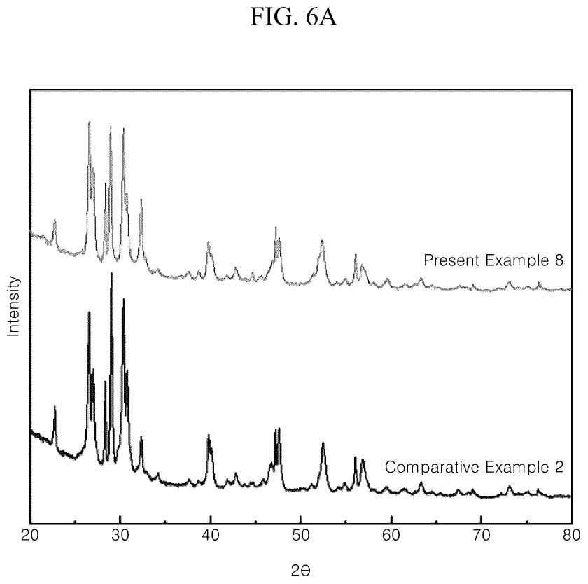

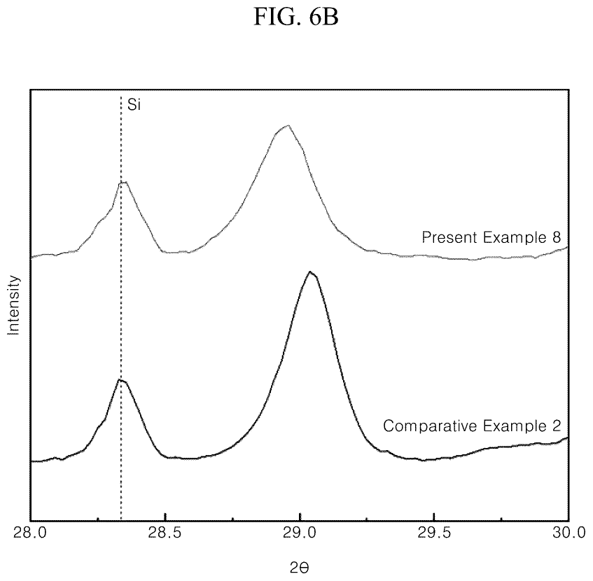

Furthermore, the results on Present Example 8 and Comparative Example 2 are shown in FIG. 6A. FIG. 6B is an enlarged image of a region around 2θ=29° of FIG. 6A.

Referring to FIG. 5A, based on a comparing result of the peaks of Comparative Example 1 and Present Example 1 to Present Example 7, it may be identified that no new Ag peak is observed despite the addition of Ag. In particular, according to FIG. 5B, it may be identified that Ag is substitutionally doped into the Li-site due to the fact that the Li peak observed at around 30° shifts to the left side as a content of AgCl increases. The fact that the Li peak shifted to the left side is predicted to be due to the increase in the interstitial distance (d) as Ag which has a larger ionic radius than that of the lithium ion is substitutionally doped into the Li-site.

Referring to FIG. 6A, based on a comparing result of the peaks of Comparative Example 2 and Present Example 8, it may be identified that no new Ag peak is observed despite the addition of Ag. In particular, according to FIG. 6B, the Li peak observed at around 29° in Comparative Example 2 shifts to the left side in Present Example 8 containing AgCl, thus indicating that Ag is substitutionally doped into the Li-site. The fact that the Li peak shifted to the left side is predicted to be due to the increase in the interstitial distance (d) as Ag which has a larger ionic radius than that of the lithium ion is substitutionally doped into the Li-site.

Thus, it was identified that regardless of the specific composition of the synthesized sulfide-based inorganic compound, the XRD peak shifted to a smaller angle when the doping element was substitutionally doped into the Li-site of the sulfide-based inorganic compound. In particular, it was observed that the higher the content of the doped Ag, the greater a shift amount.

### Manufacturing Example

A half-cell was manufactured using the sulfide-based inorganic compound according to Present Example 4.

Specifically, the sulfide-based inorganic compound prepared according to Present Example 4 and a rubber-based binder (Butadiene rubber: BR) were added to butyl butyrate (BB) as a solvent to prepare a slurry. The slurry was applied to a stainless steel thin film as a negative-electrode current collector, and dried to form the interfacial layer.

Lithium sulfide (Li₂S) powders (purchased from Sigma Aldrich), phosphorus pentasulfide (P₂S₅) powders (purchased from Sigma Aldrich), lithium chloride (LiCl) powders, and silver chloride (AgCl) powders as precursors of the sulfide-based inorganic compound were mixed with each other to prepare a raw material. The raw material was subjected to a ball milling process for uniform mixing to prepare precursor powders. The solid electrolyte precursor powders were heat-treated at about 550° C. for about 5 hours to obtain a sulfide-based Li₆PS₅Cl solid electrolyte having an argyrodite type crystal structure including Cl.

The interfacial layer was pressed against one surface of the solid electrolyte layer 30 including the sulfide-based solid electrolyte. Thereafter, a lithium foil (purchased from Honjo) was attached to the other surface of the solid electrolyte layer 30 to manufacture a half-cell.

### Experimental Example 3

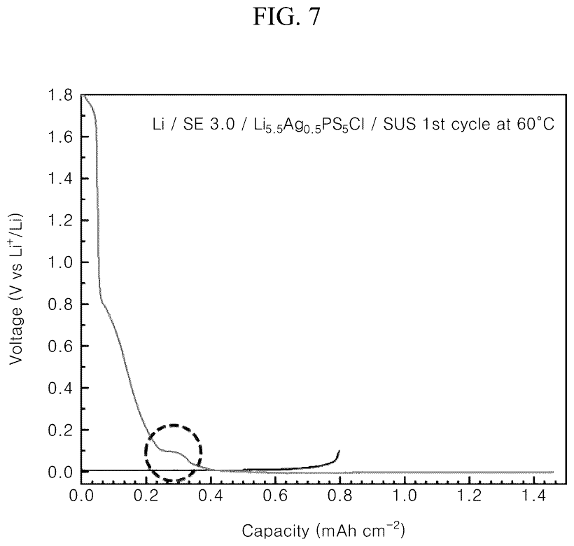

FIG. 7 shows the voltage-capacity graph when the half-cell according to the manufacturing example was initially charged and discharged at 60° C.

Referring to FIG. 7, when the half-cell was charged while decreasing the charge/discharge voltage from 1.8 V, change in a slope was observed at the charge/discharge voltage of 0.8 V. The change in the slope may mean that the sulfide-based inorganic compound included in the interfacial layer of the half-cell is converted into the coating layer.

In addition, according to FIG. 7, it may be identified that a flat level characteristic is exhibited in the voltage range of 0.2 V to 0.05 V. The flat level characteristic is observed due to the fact that the Ag produced in the sulfide-based inorganic compound reacts with the lithium ions to form the Li—Ag alloy.

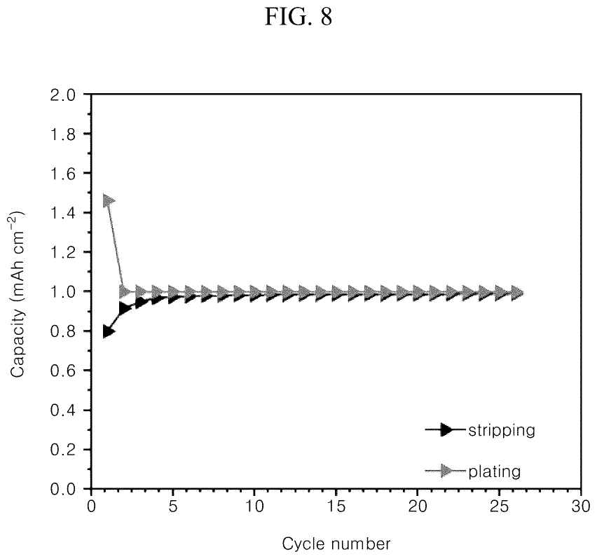

FIG. 8 shows the results of measuring the capacity of the half-cell according to the manufacturing example while increasing the charge/discharge cycle of the half-cell according to the manufacturing example.

According to FIG. 8, it may be identified that when lithium metal is plated on the negative-electrode current collector and thus the cell was charged, the cell capacity decreases at the initial cycle, and then the cell capacity is maintained until the 26th cycle of the test. Through this fact, it is identified that the cell capacity decreases at the initial charge/discharge cycle when Ag is released from the sulfide-based inorganic compound to form the Li—Ag alloy, and that excellent capacity retention rate is observed from a timing after the initial cycle when the lithium alloy is sufficiently formed.

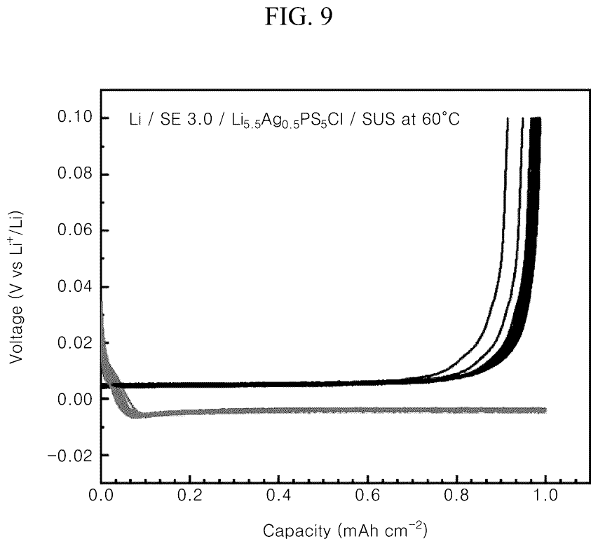

FIG. 9 is a charge/discharge graph of the half-cell at 2 to 20 cycles, and shows a voltage-capacity graph of the half-cell. Based on the fact that the shape of the graph is maintained in a constant manner, it may be identified that the charge/discharge of the half-cell is stably performed.

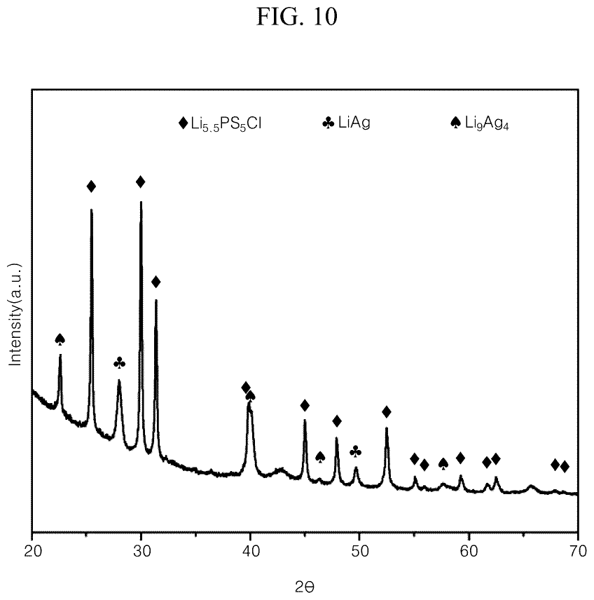

FIG. 10 is the XRD analysis result of the coating layer of the half-cell according to the manufacturing example. Referring to FIG. 10, it may be identified that a peak due to the lithium alloy represented by Li-M in the coating layer is found.

### Experimental Example 4

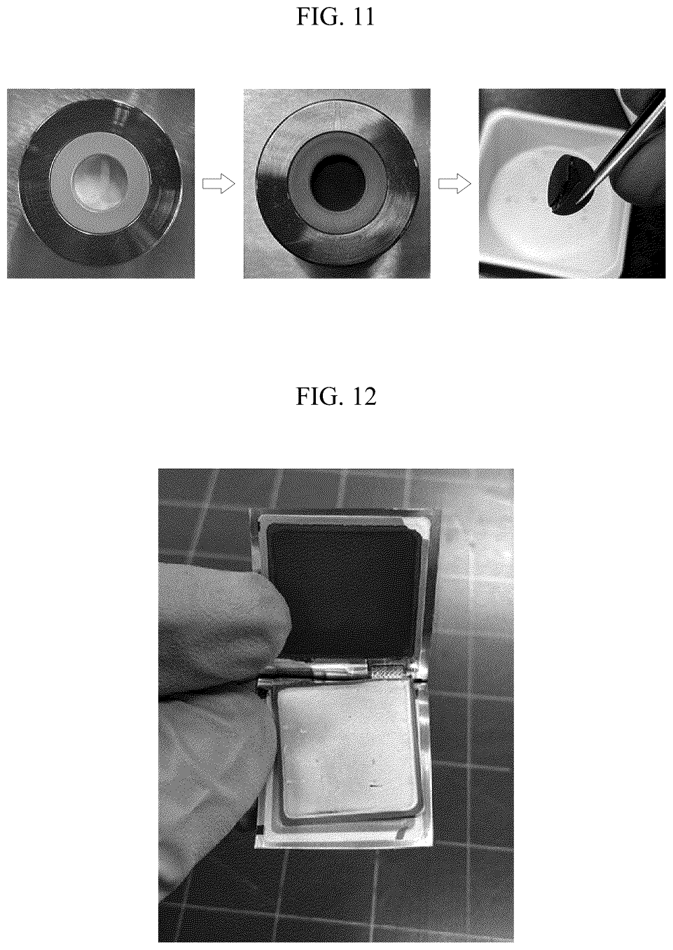

FIG. 11 shows the states of the half-cell according to the manufacturing example before and after the initial charging thereof. Referring to FIG. 11, it may be identified with the naked eye that before the initial charging of the half-cell, the lithium alloy represented by Li—Ag is not formed, so that the white interfacial layer is observed. However, it may be identified with the naked eye that after the initial charging, the lithium alloy represented by Li—Ag is irreversibly formed, so that the black coating layer is observed.

FIG. 12 shows the observation of a disassembled state of the full cell including the coating layer according to the present disclosure.

The upper dark portion refers to the coating layer, and the light edge portion refers to the solid electrolyte layer. Based on the dark color of the coating layer, it may be identified that the lithium alloy represented by Li—Ag is formed. The lower white portion in FIG. 12 refer to the lithium metal layer.

The experimental examples and examples of the present disclosure have been described in detail above. The scope of the present disclosure is not limited to the experimental examples and examples as described above, and various modifications and improvements made by those skilled in the art using the basic concept of the present disclosure defined in the following patent claim scope are also included in the scope of the present disclosure.

What is claimed is:

1. A negative-electrode-free all-solid-state battery comprising:
a negative-electrode current collector;
a coating layer disposed on the negative-electrode current collector;
a solid electrolyte layer disposed on the coating layer;
a positive-electrode active material layer disposed on the solid electrolyte layer and including a positive-electrode active material; and
a positive-electrode current collector disposed on the positive-electrode active material layer,
wherein the coating layer comprises a lithium alloy represented by Li-M, wherein M includes at least one selected from the group consisting of Ag, Na, K, Rb, Cs, Fr, and combinations thereof.

2. The negative-electrode-free all-solid-state battery of claim 1, wherein the negative-electrode-free all-solid-state battery further comprises a lithium metal layer disposed between the coating layer and the negative-electrode current collector in a charged state of the battery.

3. The negative-electrode-free all-solid-state battery of claim 1, wherein the coating layer comprises an alloy of lithium (Li) and silver (Ag).

4. The negative-electrode-free all-solid-state battery of claim 1, wherein the coating layer further comprises LiₐP_{c}S_{d}Xₑ, wherein X includes at least one selected from the group consisting of F, Cl, Br, I, and combinations thereof, wherein 0<a≤15, 0≤c≤3, 0<d≤12, and 0≤e≤3.

5. The negative-electrode-free all-solid-state battery of claim 1, wherein a thickness of the coating layer is in a range of 10 nm to 100 μm.

6. The negative-electrode-free all-solid-state battery of claim 1, wherein when the negative-electrode-free all-solid-state battery is initially charged under application of a voltage of 1.8 V to 0 V thereto, the battery exhibits a flat level characteristic at 0.2 V to 0.05 V in a graph in which an X-axis represents a battery capacity (mAh/cm²) and a Y-axis represents the voltage (V).

7. The negative-electrode-free all-solid-state battery of claim 1, wherein M in the lithium alloy represented by Li-M is derived from a sulfide-based inorganic compound represented by a following Chemical formula 1:
[Chemical formula 1]
Li_{a-b}M_{b}P_{c}S_{d}Xₑ
wherein M includes at least one selected from the group consisting of Ag, Na, K, Rb, Cs, Fr, and a combination thereof,
wherein X includes at least one selected from the group consisting of F, Cl, Br, I, and combinations thereof,
wherein 0<a≤15, 0.02≤b≤0.9, 0≤c≤3, 0<d≤12, and 0≤e≤3.

8. The negative-electrode-free all-solid-state battery of claim 7, wherein the sulfide-based inorganic compound has an argyrodite type crystal structure.

9. The negative-electrode-free all-solid-state battery of claim 7, wherein a peak appearing at 2θ=29.8°±1.0° of an XRD result of the sulfide-based inorganic compound shifts to a smaller angle as b increases.

10. A method for manufacturing a negative-electrode-free all-solid-state battery, the method comprising:
coating a sulfide-based inorganic compound represented by a following Chemical Formula 1 on a negative-electrode current collector to form an interfacial layer on the negative-electrode current collector;
stacking a solid electrolyte layer, a positive-electrode active material layer, and a positive-electrode current collector on the interfacial layer to obtain an intermediate stack; and
charging and discharging the intermediate stack to convert the interfacial layer into a coating layer including a lithium alloy represented by Li-M,
[Chemical formula 1]
Li_{a-b}M_{b}P_{c}S_{d}Xₑ
wherein M includes at least one selected from the group consisting of Ag, Na, K, Rb, Cs, Fr, and a combination thereof,
wherein X includes at least one selected from the group consisting of F, CI, Br, I, and combinations thereof,
wherein 0<a≤15, 0.02≤b≤0.9, 0≤c≤3, 0<d≤12, and 0≤e≤3.

11. The method for manufacturing the negative-electrode-free all-solid-state battery of claim 10, wherein the sulfide-based inorganic compound has an argyrodite-type crystal structure.

12. The method for manufacturing the negative-electrode-free all-solid-state battery of claim 10, wherein a peak appearing at 2θ=29.8°±1.0° of an XRD result of the sulfide-based inorganic compound shifts to a smaller angle as b increases.

13. The method for manufacturing the negative-electrode-free all-solid-state battery of claim 10, wherein the converting of the interfacial layer into the coating layer including the lithium alloy represented by Li-M is irreversible.

14. The method for manufacturing the negative-electrode-free all-solid-state battery of claim 10, wherein the interfacial layer is converted into the coating layer including the lithium alloy represented by Li-M under application of charging/discharging voltage of 0.7 V to 0.9 V to the intermediate stack.

15. The method for manufacturing the negative-electrode-free all-solid-state battery of claim 10, wherein in charging and discharging the intermediate stack to convert the interfacial layer into the coating layer, the interfacial layer of a white color is converted into the coating layer of the black color,
wherein a whiteness index of the white interfacial layer is 70 or higher,
wherein a whiteness index of the black coating layer is 30 or lower.

16. The method for manufacturing the negative-electrode-free all-solid-state battery of claim 10, wherein the negative-electrode-free all-solid-state battery further includes a lithium metal layer located between the coating layer and the negative-electrode current collector in a charged state of the battery.

17. The method for manufacturing the negative-electrode-free all-solid-state battery of claim 10, wherein the coating layer comprises an alloy of lithium (Li) and silver (Ag).

18. The method for manufacturing the negative-electrode-free all-solid-state battery of claim 10, wherein the coating layer further comprises LiₐP_{c}S_{d}Xₑ, wherein X includes at least one selected from the group consisting of F, Cl, Br, I, and combinations thereof, wherein 0<a≤15, 0≤c≤3, 0<d≤12, and 0≤e≤3.

19. The method for manufacturing the negative-electrode-free all-solid-state battery of claim 10, wherein the coating layer has a thickness in a range of 10 nm to 100 μm.

20. The method for manufacturing the negative-electrode-free all-solid-state battery of claim 10, wherein when the negative-electrode-free all-solid-state battery is initially charged under application of a voltage of 1.8 V to 0 V thereto, the battery exhibits a flat level characteristic at 0.2 V to 0.05 V in a graph in which an X-axis represents a battery capacity (mAh/cm²) and a Y-axis represents the voltage (V).
